(19) United States
(12) Patent Application Publication
(10) Pub. No.: US 2025/0309987 A1
(43) Pub. Date: Oct. 2, 2025

(54) MODULAR EQUIPMENT UNIT FOR A FIBER OPTIC NETWORK AND RELATED METHODS

(71) Applicant: CORNING RESEARCH & DEVELOPMENT CORPORATION, Corning, NY (US)

(72) Inventors: Filip Piotr Jablonski, Lodz (PL); Michal Ruda, Brzeziny (PL)

(21) Appl. No.: 19/064,913

(22) Filed: Feb. 27, 2025

Related U.S. Application Data
(60) Provisional application No. 63/572,568, filed on Apr. 1, 2024.

(51) Int. Cl. H04B 10/27

(52) U.S. Cl. CPC H04B 10/27

(57) ABSTRACT

An equipment unit for a fiber optic network includes at least one equipment module. Each equipment module includes a main frame and a carrier attached to the main frame and having a support wall moveable between a retracted position and an extended position and configured to receive network components. The carrier is attached to the main frame such that the support wall has a substantially vertical orientation relative to the equipment module. In addition, in the retracted position, the at least one support wall is positioned inside the main frame, and in the extended position, the support wall is positioned outside the main frame. A method of assembling the equipment unit and a method of expanding an existing equipment unit is also disclosed.

### PRIORITY APPLICATION

This application claims the benefit of priority of U.S. Provisional Application No. 63/572,568, filed on Apr. 1, 2024, the content of which is relied upon and incorporated herein by reference in its entirety.

### TECHNICAL FIELD

This disclosure relates generally to fiber optic connectivity in a fiber optic network, and more particularly to a modular equipment unit for holding network components at which fiber optic connections of the network are made, and to a method of making an equipment unit for the fiber optic network from one or more equipment modules.

### BACKGROUND

The large amount of data and other information transmitted over the internet has led businesses and other organizations to develop large scale fiber optic networks for organizing, processing, storing and/or disseminating large amounts of data. Network design and cabling-infrastructure architecture are becoming increasingly large and complex to handle growing industry needs. There are many different network architectures, and the various tasks required to distribute optical signals (e.g., splitting, splicing, routing, connecting subscribers) can occur at several locations. Regardless of whether a location is considered a central office, local convergence point, network access point, subscriber premise, or something else, fiber optic equipment is used to house components that carry out one or more of the tasks. The fiber optic equipment may include fiber distribution hubs (FDH), cabinets, closures, network interface devices, distribution frames, etc. Many types of fiber optic equipment include equipment racks or frames to which network components are mounted.

A passive optical network (PON), for example, is a type of optical distribution network that is comprised entirely of passive optical components. The continued growth of the internet has resulted in a corresponding increase in demand for network capacity and reliability. This demand has, in turn, caused carriers to extend their PONs closer to end users. This extension of optical fiber toward the ends of the network (e.g., node, curb, building, home, etc.) is commonly referred to as Fiber-To-The-x (FTTx). For example, in one such network configuration, carriers desire to extend their PONs all the way to user workstations within office buildings. This type of extension of carrier PONs may be referred to as Fiber-To-The-Workplace (FTTW) or Fiber-To-The-Desk (FTTD). In another network configuration, carriers desire to extend their PONs all the way to network equipment in the home. This type of extension of carrier PONs may be referred to as Fiber-To-The-Home (FTTH). FTTH in particular has been recognized by governments around the world as an essential digital infrastructure to support economic growth across urban and rural areas. Equipping more homes, offices, workstations, etc. with optical fibers will require innovative and improved management and connectivity of fiber optic cables.

The central office is often the core of FTTx networks and transmit and receive communication signals to provide services to end users. For example, the central office receives communication signals from many different carriers or providers through different communication modes (e.g., satellite signals, copper-based signals, optical signals, etc.). These communication signals are then converted into optical signals for transmission through the fiber optic network. As such, the central office often includes a large number of equipment units for holding various network components for converting and/or transmitting the communication signals that ultimately arrive at end users. By way of example, optical fibers from conversion network equipment are optically connected to optical fibers of one or more main feeder cables that emanate from the central office toward end user premises. In this regard, the equipment units may hold numerous splice modules in which the optical connections are made. More particularly, the splice modules are configured to provide the physical environment in which optical connections between incoming optical fibers, such as optical fibers from the conversion equipment, and outgoing optical fibers, such as optical fibers from main feeder cables, are made. The large number of optical fibers of the main feeder cable(s) are then branched off as needed to reach end user premises.

Equipment units in the central office typically include a rack or frame (referred to hereafter as a “frame”) for holding the network components in an organized and accessible manner. For example, in a conventional approach, the frame includes a pair of vertically arranged struts or beams that are horizontally spaced apart by a predetermined size so as to accept a standard sized network component, e.g., 19 inches, 21 inches, or 23 inches. The network components are horizontally arranged between the pair of beams and vertically stacked one above the other within the frame. Vertical spacing is divided into rack units “U”, where 1U=1.75 inches as specified in EIA (Electronic Industries Alliance) 310-D, IEC (International Electrotechnical Commission) 60297 and DIN (“German Institute for Standardization”) 41494 SC48D To access one of the network components in the stack of network components in the frame, such as to allow a technician to make or adjust desired fiber optic connections, the selected network component may be moved from a retracted position within the frame to an extended position outside of the frame. For example, the network components may be slide-out or swing-out arrangements that maintain the selected network component in the horizontal orientation. Once the technician has completed the installation or modification, the selected network component may be moved back to the retracted position while also maintaining the network component in the horizontal orientation.

A common problem in telecommunication systems, such as that of FTTx networks, is space management. Current practice in telecommunications is to utilize standard size frames that support the network components. These standard equipment units are often large, bulky frames that are oversized to allow for cable management and routing without excessive bends, etc. that can affect the optical signals in the optical fibers being routed to or from the network components. Accordingly, standard equipment units take up a relatively large amount of space in, for example, the central office of the fiber optic network. The size of standard equipment units may limit the ability of network providers to increase bandwidth capacity in the network through the addition of more network components and their associated support structures. For example, the large size of each equipment unit may prevent additional equipment units from fitting within the designated space in the central office environment.

These issues are not only present in central offices but are also present in curbside cabinets adjacent end users, for example, where a large number of splice terminals and other network components of the fiber optic network are located. For example, the one or more main feeder cables emanating from the central office and carrying the optical signals via the large number of optical fibers are often spliced to optical fibers of drop cables that are coupled to the network components in a home or workplace. For this coupling, a splice cabinet may be fixedly positioned relatively close to where a fiber optic cable enters the home or workplace. The splice cabinet holds numerous splice modules in which the optical connections are made. Space within such splice cabinets may also be at a premium and sufficient space for future expansion may be limited.

Thus, there is a need in the telecommunications industry for an equipment unit that has a reduced footprint within a fixed spaced location of the fiber optic network, such as at the central office, splice cabinet, or other housing of the fiber optic network. There is also a need for equipment units that allow expansion in an easy, cost-effective way.

### SUMMARY

In one aspect of the disclosure, an equipment unit for a fiber optic network configured to hold a plurality of network components is disclosed. The equipment unit includes at least one equipment module. Each of the at least one equipment modules includes a main frame defining an interior and exterior and at least one carrier attached to the main frame and including at least one support wall moveable between a retracted position and an extended position and configured to receive the plurality of network components. The at least one carrier is attached to the main frame such that the at least one support wall has a substantially vertical orientation. In addition, in the retracted position, the at least one support wall is positioned in the interior of the main frame, and in the extended position, the at least one support wall is positioned in the exterior of the main frame. Rearranging the at least one support wall (and the network components received thereon) to be in a vertical orientation reduces the footprint of the equipment unit compared to current designs while maintaining and possibly increasing the density of fiber optic connection made at the equipment unit.

In one embodiment, the main frame may include a rear wall, a top wall extending from an upper edge of the rear wall, and a bottom wall extending from a lower edge of the rear wall to provide, for example, a U-shaped body. Each of the rear wall, top wall, and bottom wall may include a generally planar main panel and a pair of side rails at opposed side edges of the main panel. In one embodiment, the main panel and the pair of side rails may be integrally formed to define a monolithic construction for each of the walls. In an alternative embodiment, the main panel and the pair of side rails may be separate elements that are connected to form the walls. Furthermore, in one embodiment, the rear wall, top wall, and bottom wall may be integrally formed to define a monolithic construction (i.e., the U-shaped body is monolithic). In an alternative embodiment, the rear wall, top wall, and bottom wall may be separate elements that are connected to form the U-shaped body of the main frame.

In one embodiment, the at least one carrier may include a first slider attached to the main frame and the at least one support wall, and a second slider attached to the main frame and the at least one support wall. In this embodiment, the at least one support wall may be configured to be slidable between the retracted position and the extended position. In one embodiment, each of the first slider and the second slider may include a mounting bracket configured to be attached to the main frame and one or more arms configured to be slidably attached to the mounting bracket. In one embodiment, for example, the first slider may be attached to the top wall of the main frame and the second slider may be attached to the rear wall of the main frame.

In one embodiment, the at least one equipment module may further include an access panel attached to the main frame and moveable between a closed position and an opened position. The access panel is configured to provide selective access to the plurality of network components associated with the equipment unit, such as by a technician. For example, in one embodiment, the access panel may be rotatably attached to the main unit and pivotable between the closed position and the opened position. In one embodiment, the at least one equipment module may further include a pair of door jambs attached to the main frame and the access panel may be attached to at least one of the pair of door jambs. The door jambs increase the strength of the equipment module and support the access panel during its movements between the closed and opened positions.

In one embodiment, the equipment unit may include a pair of side walls for closing off the interior of the equipment unit. In one embodiment, each of the pair of side walls may be releasably attached to the main frame of one of the at least one equipment modules of the equipment unit. In one embodiment, for example, each of the pair of side walls may include one or more tabs and the one of the main frames may include a corresponding one or more slots. In this embodiment, the one or more tabs may be configured to engage with the corresponding one or more slots when the pair of side walls are attached to the main frame of the one of the at least one equipment modules of the equipment unit. Moreover, in one embodiment, each of the pair of side walls may include at least one releasable snap fit connector configured to engage with the main frame of the one of the at least one equipment modules of the equipment unit. For example, the at least one snap fit connector may include at least one spring pin that cooperates with openings in the main frame to provide the snap fit connection.

In one embodiment, the at least one equipment module may include a plurality of equipment modules arranged in a side-by-side manner. In this embodiment, each of the plurality of equipment modules may be connected to at least one other equipment module of the plurality of equipment modules. For example, the main frames of adjacent equipment modules may be connected to each other to form the equipment unit from the plurality of equipment modules. When the equipment unit includes a plurality of equipment modules, the pair of side walls may be connected to the endmost equipment modules that form the equipment unit.

In another aspect of the disclosure, a method of assembling an equipment unit for a fiber optic network configured to hold a plurality of network components is disclosed. The equipment unit includes at least one equipment module. For each of the at least one equipment modules, the method includes providing a main frame of the at least one equipment module that defines an interior and an exterior and attaching at least one carrier to the main frame. The at least one carrier includes a least one support wall moveable between a retracted position and an extended position and configured to receive the plurality of network components. According to the method, attaching the at least one carrier to the main frame includes attaching the at least one carrier to the main frame so that: i) the at least one support wall has a substantially vertical orientation; ii) in the retracted position, the at least one support wall is positioned in the interior of the main frame; and iii) in the extended position, the at least one support wall is positioned in the exterior of the main frame.

In one embodiment of the method, attaching the at least one carrier to the main frame may include attaching the at least one carrier to the main frame so that the at least one support wall is slidable between the retracted position and the extended position. In one embodiment, the method may further include attaching an access panel to the main frame so as to be moveable between a closed position and an opened position. The access panel may be configured to provide selective access to the plurality of network components in the equipment unit. For example, attaching the access panel to the main frame may include attaching the access panel to the main frame so as to be rotatable between the closed position and the opened position. In one embodiment, attaching the access panel to the main frame may further include attaching a pair of door jambs to the main frame and attaching the access panel to at least one of the pair of door jambs.

In one embodiment, the method may include attaching a pair of side walls to the main frame of the one of the at least one equipment modules of the equipment unit. For example, attaching the pair of side walls to the main frame of the one of the at least one equipment modules of the equipment unit may include attaching each of the pair of side walls to the main frame through a slip fit. Additionally, or alternatively, attaching the pair of side walls to the main frame of the one of the at least one equipment modules of the equipment unit may include attaching each of the pair of side walls to the main frame through a snap fit.

In one embodiment, the main frame may include a rear wall, top wall, and bottom wall, and providing the main frame may include attaching each of the top wall and the bottom wall to the rear wall to form the main frame. Each of the rear wall, top wall, and bottom wall may include a main panel and a pair of side rails, and providing the main frame may include connecting each pair of side rails to its corresponding main panel.

In one embodiment, the equipment unit may include a plurality of equipment modules, and the method may further include attaching the main frame of each of the plurality of equipment modules to the main frame of at least one adjacent equipment module of the plurality of equipment modules so as to arrange the plurality of equipment modules in a side-by-side manner. For example, in one embodiment, the equipment unit may include a first end equipment module and a second end equipment module, and attaching the pair of side walls may include attaching one of the pair of side walls to the main frame of the first end equipment module and attaching the other of the pair of side walls to the main frame of the second end equipment module.

In a further aspect of the disclosure, a method of expanding the capacity of an equipment unit for a fiber optic network is disclosed. The equipment unit is formed from at least one equipment module and is configured to hold a plurality of network components. The method includes removing a side wall from the equipment unit at a selected end of the equipment unit, providing a main frame of an additional equipment module that defines an interior and an exterior, attaching at least one carrier to the main frame of the additional equipment module, the at least one carrier including a least one support wall moveable between a retracted position and an extended position and configured to releasably receive the plurality of network components, attaching an access panel to the main frame of the additional equipment module, and reattaching the previously removed side wall to the main frame of the additional equipment module. According to the method, attaching the at least one carrier to the main frame of the additional equipment module may include attaching the at least one carrier to the main frame so that: i) the at least one support wall has a substantially vertical orientation; ii) in the retracted position, the at least one support wall is positioned in the interior of the main frame of the additional equipment module; and iii) in the extended position, the at least one support wall is positioned in the exterior of the main frame of the additional equipment module.

Additional features and advantages will be set forth in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a schematic view illustrating an exemplary FTTx carrier network in which embodiments of the disclosure may be used.

FIG. 2 is a perspective view of an equipment unit according to known designs wherein the network components have a substantially horizontal orientation within the equipment unit.

FIG. 3 is a perspective view of an equipment unit formed from one equipment module according to an embodiment of the disclosure.

FIG. 4 is a disassembled perspective view of the equipment unit shown in FIG. 3.

FIG. 5 is a perspective view of the equipment unit shown in FIG. 3 in the opened position and with the network components accessible to a technician.

FIG. 6 is a perspective view of an equipment unit formed from a plurality of serially connected equipment modules according to another embodiment of the disclosure.

FIG. 7 is a partially disassembled perspective view of the equipment unit shown in FIG. 6.

### DETAILED DESCRIPTION

Various embodiments will be further clarified by examples in the description below. In general, the description relates to an improved equipment unit for a fiber optic network that is configured to hold a plurality of network components, such as splice modules. The equipment unit is arranged so as to have a reduced footprint (e.g., area on the floor of a facility) as compared to existing equipment units. This is primarily achieved by changing the orientation of the network components held by the equipment unit. Conventional equipment units typically arrange network components in the equipment unit in a horizontal orientation. In the current approach, however, the orientation of the network components is arranged in the equipment unit so as to be in a substantially vertical orientation. In many cases, equipment units provide supports, such as shelves or other panels or walls for supporting and holding the network components in the equipment units. Thus, in the current approach, such support structures may also have a change in orientation so as to be substantially vertical. In the vertical orientation, such support structures may be configured to receive network components on both sides of the structures. Thus, a high density of network components may be achieved while reducing the footprint of the equipment unit in the network environment.

In addition to the above, the equipment unit may have a modular design. In this regard, a plurality of equipment modules may be connected to each other in a side-by-side manner to form the equipment unit. This allows tremendous flexibility in designing different size equipment units for different applications and scenarios. Additionally, the modular nature of the equipment units allows existing equipment units to be expanded in a relatively easy and straight forward manner. For example, when an increase in capacity is desired, an additional equipment module may be added one of the ends of the existing equipment unit. Again, this allows network providers to provide increased capacity without much disruption to existing network architectures and devices.

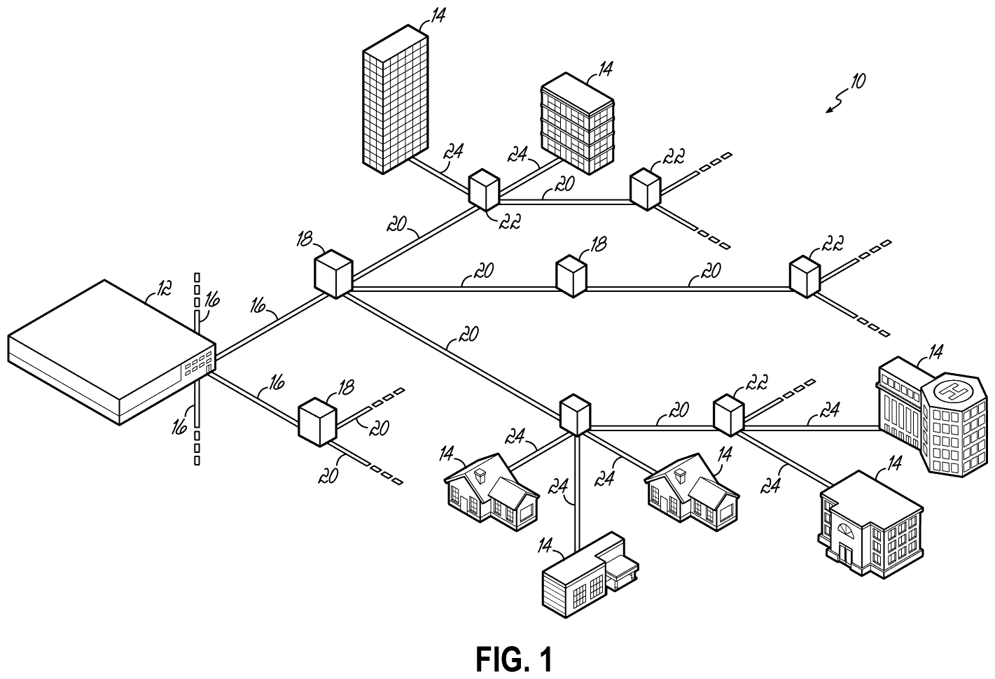

As illustrated in FIG. 1, an exemplary FTTx carrier network 10 distributes optical signals generated at a switching point 12 (e.g., a central office) to one or more subscriber premises 14. Optical line terminals (OLTs—not shown) at the switching point 12 convert electrical signals into optical signals. Fiber optic feeder cables 16 then carry the optical signals to various local convergence points 18. The convergence points 18 act as locations for making cross-connections and interconnections (e.g., by splicing or patching cables). The local convergence points 18 often include splitters or wavelength division multiplexing (WDM) components to enable any given optical fiber in the feeder cable 16 to serve multiple subscriber premises 14. As a result, the optical signals are “branched out” from the optical fibers of the feeder cables 16 to optical fibers of fiber optic distribution cables 20 that exit the local convergence points 18.

At remote network access points 22 closer to the subscriber premises 14, some or all of the optical fibers in the distribution cables 20 may be accessed to connect to one or more subscriber premises 14. Drop cables 24 extend from the remote network access points 22 to the subscriber premises 14, which may be single-dwelling units (SDU), multi-dwelling units (MDU), businesses, and/or other facilities or buildings. An optical network terminal (ONT—not shown) located at or inside the subscriber premises 14 receives one or more optical signals and converts the optical signals back to electrical signals at the remote distribution points or subscriber premises 14. Equipment units, including various equipment racks, frames, etc. may be located in any single one or each of the switching points 12, local convergence points 18, and remote network access points 22 in the carrier network 10. While aspects of the disclosure are described below in the context of a carrier network 10, it should be understood that aspects of the disclosure may be used in other fiber optic network contexts, such as that provided in a data center or other processing centers.

As discussed above, various locations of the fiber optic network 10 may include equipment units holding, for example, a plurality of splice modules for making fiber optic connections between one or more first optical fibers and one or more second optical fibers. The first optical fibers may be incoming optical fibers to the splice modules and the second optical fibers may be outgoing optical fibers from the splice modules. For example, in one embodiment, the incoming optical fibers may be from the OLTs at the switching point 12 of the fiber optic network 10 and the outgoing optical fibers may be from the one or more feeder cables 16 of the fiber optic network 10. In an alternative embodiment, the incoming optical fibers may be from the one or more feeder cables 16 or the distribution cables 20 of the fiber optic network 10 and the outgoing optical fibers may be from one or more drop cables 24 of the fiber optic network 10 (e.g., such as that which might be found in a remote network access points 22). However, what constitutes the incoming optical fibers and the outgoing optical fibers may depend on the particular context, architecture, location, etc. of the fiber optic network and should not be limited to any particular optical fibers of the network. The terms “incoming optical fibers” and “outgoing optical fibers” are used to differentiate the optical fibers being connected at the splice module, for example. The terms do not limit applications to unidirectional optical signals in a fiber optic network. Indeed, bidirectional optical communications are contemplated to be within the scope of the present disclosure. Regardless of the particular source of the incoming and outgoing optical fibers, these fibers are configured to be optically connected via the splice module.

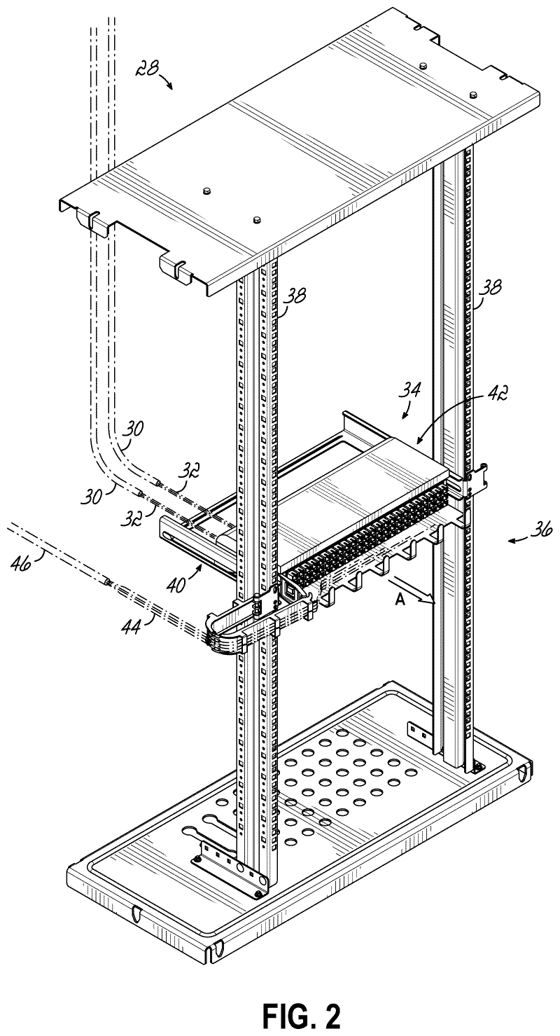

FIG. 2 illustrates an equipment unit 28 that receives one or more incoming fiber optic cables 30 carrying a plurality of incoming optical fibers 32, which may be optical fibers from any one of the cables from the OLTs at the switching point 12, feeder cables 16, distribution cables 20, or drop cables 24 in FIG. 1. The equipment unit 28 is configured to support one or more network components 34 to which at least a portion of the incoming fiber optic cables 30 may be routed. In that regard, and in an exemplary embodiment, the equipment unit 28 may include a housing 36 for holding network components 34 and receives the incoming fiber optic cables 30 within its interior. Moreover, the equipment unit 28 may include a pair of vertical frame members 38 between which each network component 34 may be supported. The vertical frame members 38 generally define a space within the equipment unit 28 for each network component 34. While embodiments of the network component 34 are not generally limited in dimension, the network component 34 may be scalable to meet 19″, 21″, and 23″ or other equipment standards. The network component 34 is generally installed and removable from a front side of the equipment unit 28. Although only a single network component 34 is shown in FIG. 2, additional network components 34 may be mounted to the vertical frame members 38 to populate the entirety or a substantial portion of a height of the equipment unit 28 along the vertical frame members 38. Optical fibers 32 from one or more incoming fiber optic cables 30 may then be routed to and terminated within each network component 34, as is generally known in the telecommunications industry.

As further illustrated in FIG. 2, in one embodiment, the network component 34 may include a mounting arrangement 40 configured to be connected to the vertical frame members 38 and one or more network components 34, which may be in the form of one or more splice modules 42, supported by the mounting arrangement 40. The mounting arrangement 40 may be configured to receive a single splice module 42 but may include additional splice modules in alternative embodiments (not shown). The splice module 42 is configured to receive the incoming optical fibers 32 from the one or more incoming fiber optic cables 30 and optically connect those incoming optical fibers 32 to outgoing optical fibers 44 from one or more outgoing fiber optic cables 46. Depending on the location within the fiber optic network 10, the outgoing optical fibers 44 may be from any one of the feeder cables 16, distribution cables 20, or drop cables 24 in FIG. 1, for example.

The mounting arrangement 40 is configured to allow the splice module 42 to move between a retracted position, where the splice module 42 is generally positioned within the equipment unit 28 (shown in FIG. 2), and an extended position, where the splice module 42 is generally positioned outside the equipment unit 28 (not shown). In the extended position, the splice module 42 is accessible by a technician or the like for making and/or modifying optical connections between the splice module 42 and the incoming optical fibers 32 and/or the outgoing optical fibers 44. In the illustrated embodiment, the splice module 42 is slidable between the retracted position and the extended position as illustrated by arrow A. In an alternative embodiment (not shown), however, the splice module may be rotatable (e.g., pivotable about a vertical axis at the left side or the right side of the splice module) between the retracted position and the extended position. In these various embodiments, the splice module 42 is mounted to the equipment unit 28 in a generally horizontal orientation and moves between the retracted position and the extended position while maintaining its horizontal orientation. The horizontal orientation of the splice modules 42 generally requires the equipment unit 28 to be relatively large in order to accommodate the splice modules 42 and the fiber optic cables running to and from the splice modules 42. The relatively large size of the equipment units 28 limits the ability of network providers to expand and increase capacity, especially within a fixed space environment.

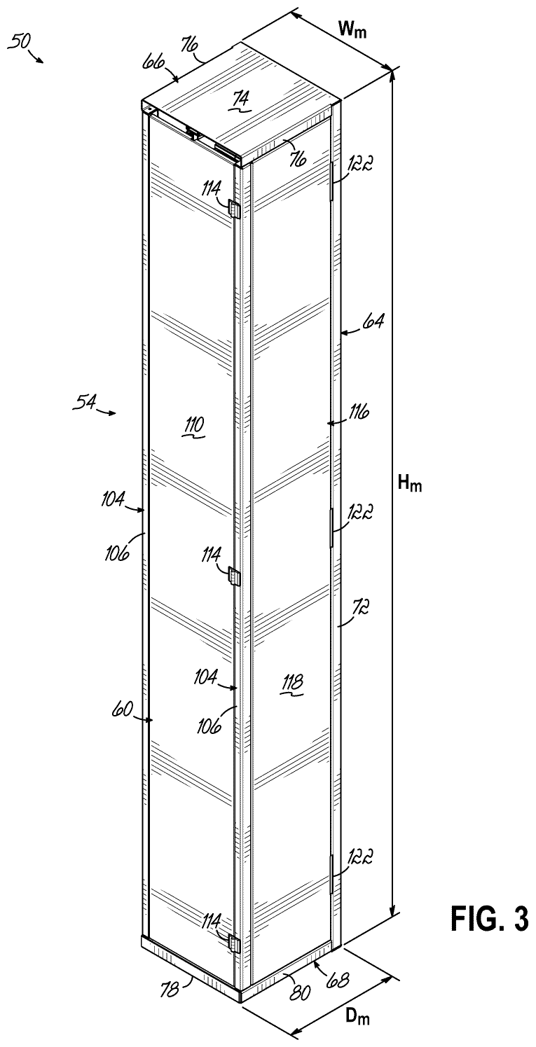

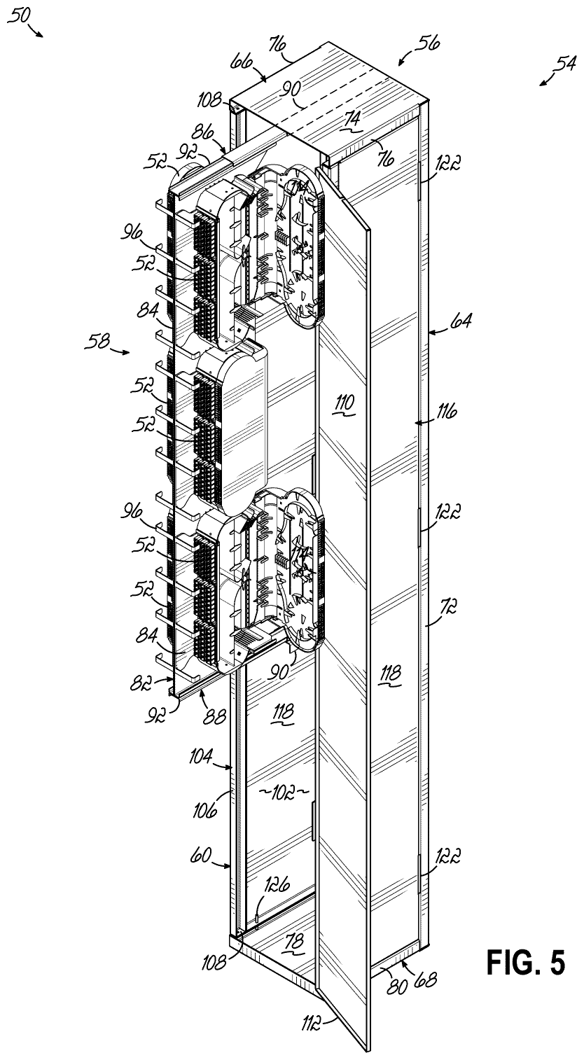

FIG. 3 illustrates an equipment unit 50 in accordance with an embodiment of the disclosure that forms part of a fiber optic network, such as a carrier network 10 (FIG. 1) and configured to hold a plurality of network components 52 (FIG. 5) that facilitates operation of the fiber optic network 10. In one aspect of the disclosure, the equipment unit 50 is designed to have a relatively small footprint, as compared to conventional equipment units 28 as shown and described above. However, the number of fiber optic connections that are configured to be made in the equipment unit 50 is configured to remain about the same as conventional equipment units 28 or preferably increase. Thus, the equipment unit 50 is configured to have an increased density of fiber optic connections per area of floor space occupied by the equipment unit 50. This, in turn, will allow more equipment units 50 to be located within a fixed space environment in, for example, a central office, splice cabinet, data center, or other hub or terminal of a fiber optic network. As will be explained in more detail below, the increased density in fiber optic connections is premised on changing the arrangement of the network components 52 in the equipment unit 50 to be in a generally vertical orientation instead of a generally horizontal orientation. This change in orientation allows the width of the equipment unit 50 to be significantly reduced without a corresponding increase in the depth of the equipment unit 50. Thus, additional equipment units 50 may be provided in a fixed, designated space of the network environment.

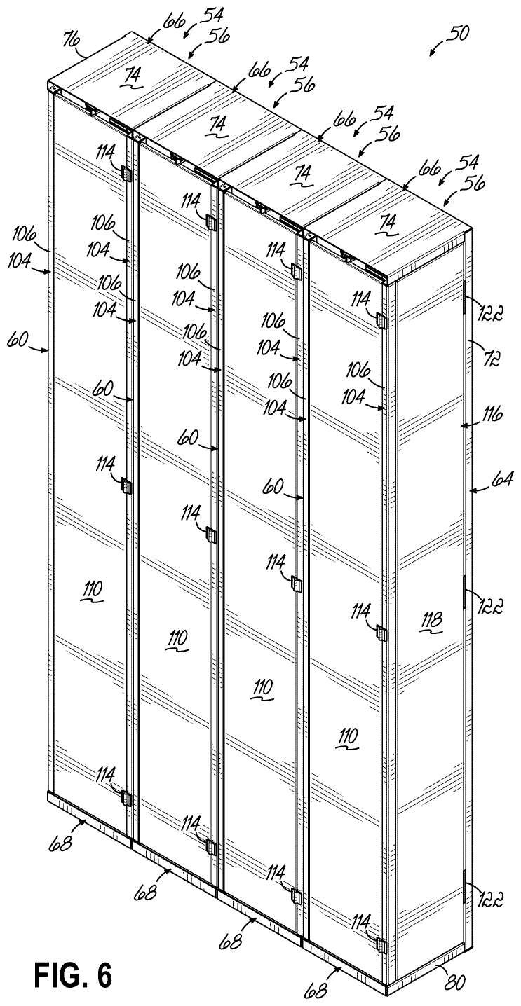

In a further aspect of the disclosure, the equipment unit 50 is modular in its construction. In particular, the equipment unit 50 may include one or more equipment modules 54 that collectively define the equipment unit 50. For example, the equipment modules 54 may be configured to connect to adjacent equipment modules 54 in a side-by-side manner to form the equipment unit 50 (e.g., see FIG. 6). The modularity of the equipment unit 50 allows the size of the equipment unit 50 to be easily varied on original installations. Thus, for example, a 3-module equipment unit 50 or a 5-module equipment unit 50 may be installed as part of the construction of the fiber optic network 10. Moreover, the expansion of equipment units 50 at a later time, for example, may be achieved in a relatively easy and straight forward manner by simply adding addition equipment modules 54, such as at an end of an existing equipment unit 50.

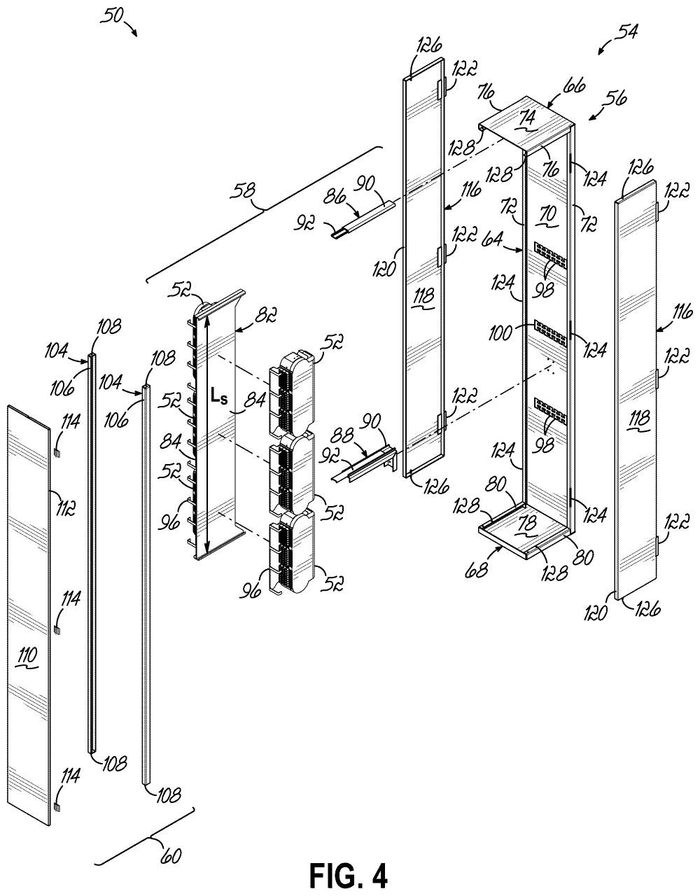

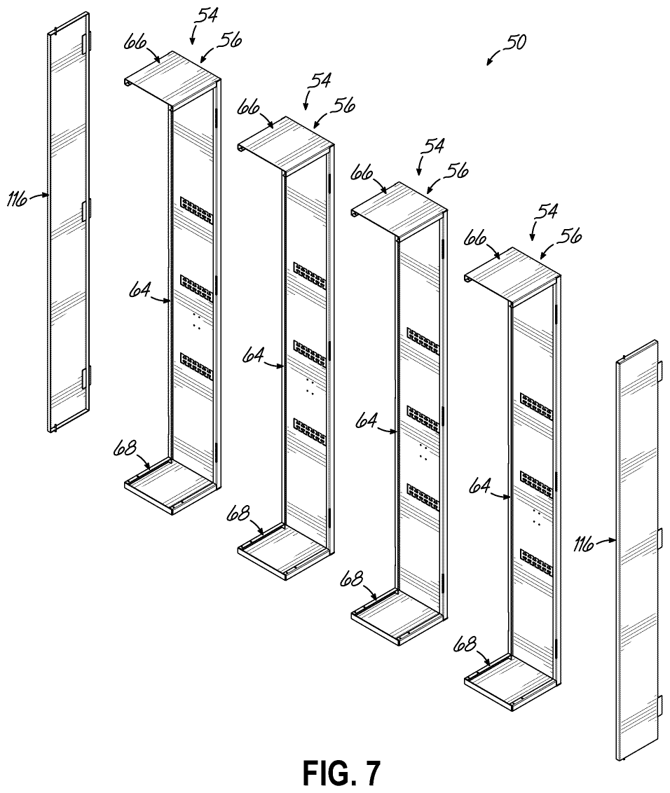

The equipment unit 50 illustrated in FIGS. 3 and 4 includes but a single equipment module 54. Thus, the description of the equipment unit 50 will primarily be in the context of an equipment module 54. However, as will be described below in reference to FIGS. 6 and 7, aspects of the disclosure are not limited to an equipment unit 50 having only one equipment module 54. Indeed, in alternative embodiments, the equipment unit 50 may include a plurality of equipment modules 54, such as three equipment modules 54, five equipment modules 54, or even more equipment modules 54. Thus, aspects of the disclosure should not be limited to any particular number of equipment modules 54 that collectively form the equipment unit 50.

As perhaps best illustrated in FIG. 4, an equipment module 54 may include a main frame 56, at least one carrier 58 attached to the main frame 56 and configured to hold a plurality of network components 52, and an access panel 60 configured to provide selective access to the network components 52 associated with the at least one carrier 58 in the equipment module 54. In one embodiment, the main frame 56 may include a U-shaped body having an elongate rear wall 64 that generally defines a height Hₘ of the equipment module 54, a top wall 66 extending from an upper edge of the rear wall 64, and a bottom wall 68 extending from a lower edge of the rear wall 64. The bottom wall 68 is configured to engage with a support surface (e.g., floor) of a facility or enclosure to support the equipment module 54. In one embodiment, the top wall 66 and the bottom wall 68 extend from the rear wall 64 at an angle of about 90 degrees and generally define a width Wₘ and a depth Dₘ of the equipment module 54. As noted above, the footprint of the equipment module 54 has been reduced relative to conventional equipment units used in the telecommunications industry. By way of example, and without limitation, in one embodiment, the equipment module 54 may have a width Wₘ of up to and including about 300 millimeters (mm) and depth Dₘ of up to and including about 300 mm, thus providing a footprint per equipment module 54 of about 0.09 square meters (m²). A single equipment unit 50 of such dimensions reduces the footprint of the equipment unit 50 as compared to a single conventional unit. In some embodiments, the reduction in the footprint of the equipment unit 50 ranges between about a 10% and about a 20% compared to conventional units. In one embodiment, the height Hₘ of the equipment module 54 may be up to and including about 2.2 meters (m). It should be understood that these dimensions are merely exemplary and the width Wₘ, depth Dₘ, and height Hₘ of the equipment module 54 may be different and remain within the scope of the present disclosure.

In one embodiment, the rear wall 64 may include a generally planar main panel 70 and a pair of side rails 72 extending along the lateral side edges of the main panel 70 to provide strength to the rear wall 64. In one embodiment, the side rails 72 may be separate elements that are attached to the main panel 70 by fasteners, such as screws, bolts, rivets or the like. In another embodiment, however, the side rails 72 may be integrally formed with the main panel 70 such that the rear wall 64 has a substantially monolithic construction. In this regard, and by way of example, the rear wall 64 may be formed from a single sheet metal blank that is bent or folded to form the main panel 70 and the side rails 72 as integral elements. Machines and processes for bending sheet metal are well known and a further description will not be provided herein. It should be understood, however, that the rear wall 64 may be made from other materials and from other processes. For example, the rear wall 64 may be made from a plastic material through a molding process.

In one embodiment, the top wall 66 and the bottom wall 68 may have a similar design. More particularly, the top wall 66 may include a generally planar main panel 74 and a pair of side rails 76 extending along the lateral side edges of the main panel 74 to provide strength to the top wall 66. In one embodiment, the side rails 76 may be separate elements that are attached to the main panel 70 by fasteners, such as screws, bolts, rivets or the like. In another embodiment, the side rails 76 may be integrally formed with the main panel 74 such that the top wall 66 has a substantially monolithic construction. In this regard, and by way of example, the top wall 66 may be formed from a single sheet metal blank that is bent or folded to form the main panel 74 and the side rails 76 as integral elements. In a similar manner, the bottom wall 68 may include a generally planar main panel 78 and a pair of side rails 80 extending along the lateral side edges of the main panel 78 to provide strength to the bottom wall 64. In one embodiment, the side rails 80 may be separate elements that are attached to the main panel 78 by fasteners, such as screws, bolts, rivets or the like. In another embodiment, the side rails 80 may be integrally formed with the main panel 78 such that the bottom wall 68 has a substantially monolithic construction. In this regard, and by way of example, the bottom wall 68 may be formed from a single sheet metal blank that is bent or folded to form the main panel 78 and the side rails 80 as integral elements. Similar to the above, it should be understood that the top wall 66 and bottom wall 68 may be made from other materials and from other processes. For example, these walls may be made from a plastic material through a molding process.

In one embodiment, the top wall 66 and bottom wall 68 may be separate elements that are connected to the rear wall 64 by fasteners, such as screws, bolts, rivets or the like. In another embodiment, however, the top wall 66 and bottom wall 68 may be integrally formed with the rear wall 64 such that the main frame 56 has a substantially monolithic construction. In this regard, and by way of example, the main frame 56 may be formed from a single sheet metal blank that is bent or folded to form each of the rear wall 64, top wall 66, and bottom wall 68, including, for example, their main panels and side rails. Forming the main frame 56 as a substantially monolithic structure is configured to ease manufacturing, reduce costs, simplify assembly, and increase the strength of the main frame 56, and more particularly the equipment module 54 that forms the equipment unit 50. However, as noted above, aspects of the disclosure are not limited to the main frame 56 having a monolithic construction.

As illustrated in FIGS. 4 and 5, the equipment module 54 includes at least one carrier 58 attached to the main frame 56 of the equipment module 54 and configured to hold the plurality of network components 52 of the fiber optic network 10. In one embodiment, the at least one carrier 58 may include at least one support wall 82 that defines opposed surfaces 84 on which the network components 52 may be received and releasably secured. As was discussed above, the at least one support wall 82 does not have a generally horizontal orientation relative to the equipment module 54, similar to current rack or frame designs. Instead, and in accordance with an embodiment of the disclosure, the at least one support wall 82 may have a substantially vertical orientation relative to the equipment module 54. In other words, the opposed surfaces 84 of the at least one support wall 82 may form substantially vertical parallel planes. As used herein, the term “substantially vertical” means parallel to the direction of gravity +\−10 degrees, preferably within +\−5 degrees of the direction of gravity, and even more preferably within +\−2 degrees of the direction of gravity. In this orientation, for example, gravity cannot be used to ensure engagement of the network components 52 to the at least one support wall 82. Instead, the network components 52 must be positively attached to the at least one support wall 82, such as with screws, clamps, ties, bolts, or other suitable fasteners. However, the vertical orientation of the at least one support wall 82 lends itself to using both surfaces 84 of the at least one support wall 82 to hold the network components 52. This contrasts with horizontally oriented network components, which typically are located only on an upper side of a support shelf or similar support structure. Thus, the vertical arrangement of the at least one support wall 82 in equipment module 54 facilitates a more compact design, and thus a smaller footprint for the equipment module 54.

In one embodiment, the at least one support wall 82 may be configured to be movably attached to the main frame 56 of the equipment module 54. For example, the main frame 56 generally defines, at least in part, an interior and an exterior to the equipment module 54. In one embodiment, the at least one support wall 82 may be configured to be movably attached to the main frame 56 between a retracted position, where the network components 52 associated with the at least one support wall 82 are generally positioned in the interior of the equipment module 54 (FIG. 3), and an extended position, where the network components 52 associated with the at least one support wall 82 are generally positioned exterior to the equipment module 54 (FIG. 5). In this way, for example, technicians or the like may access the network components 52 associated with the equipment module 54 when the at least one support wall 82 is in the extended position.

In one embodiment, the at least one support wall 82 may be configured to be slidable between the retracted position and the extended position. For example, in this embodiment, the at least one carrier 58 may include a pair of sliders 86, 88 each being attached to the main frame 56 and each being attached to the at least one support wall 82. In one embodiment, for example, the at least one carrier 58 may include an upper slider 86 attached to the underside of the top wall 66 of the main frame 56 and a lower slider 88 attached to the rear wall 64 of the main frame 56 and extending therefrom. An upper edge of the at least one support wall 82 may be attached to the upper slider 86 and a lower edge of the at least one support wall 82 may be attached to the lower slider 88. In one exemplary embodiment, each of the upper slider 86 and the lower slider 88 may include a mounting bracket 90 fixedly attached to the main frame 56 and one or more (telescoping) arms 92 slidably connected to the mounting bracket 90. In the retracted position of the at least one support wall 82, the one or more arms 92 may be collapsed to be generally within the mounting brackets 90. In the extended position of the at least one support wall 82, however, the one or more arms 92 may be configured to extend away from mounting brackets 90 so as to extend outside of the equipment module 54 (see FIG. 5). Such sliders 86, 88 are generally well-known items, and a further description of the sliders 86, 88 will be omitted herein for sake of brevity.

As mentioned above, and illustrated in FIGS. 4 and 5, the at least one support wall 82 of the at least one carrier 58 is configured to receive network components 52 on both opposed sides 84 of the at least one support wall 82. Thus, in one embodiment, the at least one support wall 82 may be configured to be positioned substantially along the vertical midplane of the rear wall 64 of the main frame 56 when the at least one carrier 58 is mounted to the main frame 56. For example, the at least one support wall 82 may be located in the range between about 40% and about 60% of the width Wₘ of the equipment module 54 (e.g., when viewed from a front of the equipment module 54). This arrangement provides sufficient space on both sides of the at least one support wall 82 to accommodate the network components 52, such as a splice module, for example, as well as the cabling associated with the network components 52. The width Wₛ of the at least one support wall 82 may be less than to the depth Dₘ of the equipment module 54 so that when the at least one support wall 82 is in the retracted position, the at least one carrier 58 may be substantially contained within the interior of the equipment module 54.

The length Lₛ of the at least one support wall 82 may vary depending on the particular application and, for example, the number of network components 52 being held by the at least one support wall 82. By way of example, in one embodiment, the length Lₛ of the at least one support wall 82 may be sufficient to hold four network components 52 (e.g., splice modules), i.e., two network components 52 on each of the opposed surfaces 84 of the at least one support wall 82. In an alternative embodiment, the length Lₛ of the at least one support wall 82 may be sufficient to hold six network components 52, i.e., three network components 52 on each of the opposed surfaces 84 of the at least one support wall 82, as shown in FIG. 5. In further embodiments, the at least one support wall 82 may be configured to hold more or less network components 52. As illustrated in the figures, in one embodiment, the equipment module 54 may be configured to include one support wall 82 moveable between the retracted position and the extended position. In an alternative embodiment, however, the equipment module 54 may be configured to include more than one support wall 82, each being independently moveable between the retracted position and the extended position. In one embodiment, the at least one support wall 82 may be made from one continuous wall portion. In an alternative embodiment, however, the at least one support wall 82 may be an assembly formed from several wall portions attached together to collectively form the at least one support wall 82.

As noted above, the at least one carrier 58 of the equipment module 54 is configured to hold a plurality of network components 52 on both surfaces 84 of the at least one support wall 82. FIG. 5, for example, illustrates an arrangement where six network components 52 are secured to the at least one support wall 82, i.e., three network components 52 secured to each surface 84 of the at least one support wall 82. Aspects of the invention are not limited to the network components 52 taking a certain form. In an exemplary embodiment, the network components 52 may take the form of a splice module 42. By way of example, and without limitation, splice modules disclosed in U.S. Provisional Application No. 63/604,516, the disclosure of which is incorporated by reference herein in its entirety, may be used in accordance with aspects of the present disclosure. However, other known splice modules may also be used in accordance with aspects of the present disclosure. Moreover, other types of network components 52 may be used in accordance with aspects of the present disclosure. By way of example, and without limitation, the network components 52 may include optical splitters, wavelength division multiplexing (WDM) modules, and dense wavelength division multiplexing (DWDM) devices and combinations thereof. Thus, aspects of the present disclosure should not be limited to a particular network component 52 to be held in the equipment module 54 of the equipment unit 50.

Regardless of the particular network component 52 being held by the equipment module 54, the equipment module 54 typically includes a large number of fiber optic cables coming to and from the equipment module 54. Accordingly, cable management is also an important feature in the equipment module 54. In this regard, as illustrated in FIG. 5, in one embodiment, the network components 52 themselves may provide cable management features. For example, the network components 52 may include cable guides 96 for organizing and guiding the fiber optic cables extending from the front patch panels of the network components 52. Additionally, and as best shown in FIG. 4, the equipment module 54 may include one or more strain relief elements 98 to organize and protect the cables from excessive strain. In the illustrated embodiment, for example, the rear wall 64 of the main frame 56 may include a plurality of strain relief elements 98. The strain relief elements 98 may be divided into strain relief fields 100 that are generally aligned with the network components 52 being held in the equipment module 54. Aspects of the disclosure should not be limited to the plurality of strain relief elements 98 being positioned in any particular location. For example, depending on the cabling scheme, additional cable guides and strain relief elements may be positioned throughout the equipment module 54. Moreover, the equipment module 54 is configured to provide a cable storage area 102 generally below the at least one carrier 58 for providing sufficient space to manage the fiber optic cables associated with the network components 52 in the equipment module 54.

As noted above, the equipment module 54 includes an access panel 60 that provides selective access by technicians or the like to the interior of the equipment module 54. This may allow the technicians to install and/or modify fiber optic connections made at the network components 52 positioned within the equipment module 54. In one embodiment, the access panel 60 may be movably attached to a front of the equipment module 54 so as to be movable between a closed position (FIG. 3), where the interior of the equipment module 54 is inaccessible from a front of the equipment module 54, and an opened position, where the interior of the equipment module 54 is accessible from a front of the equipment module 54. In one embodiment, the access panel 60 may be rotatably attached to the main frame 56 of the equipment module 54. For example, the access panel 60 may be hingedly attached to the main frame 56 of the equipment module 54.

In this regard, and as illustrated in FIGS. 4 and 5, to accommodate the access panel 60, the equipment module 54 may include a pair of door jambs 104 each of which extends from the top wall 66 to the bottom wall 68 at the front of the equipment module 54. More particularly, each door jamb 104 may be attached to the side rail 76 of the top wall 66 and the side rail 80 of the bottom wall 68 using one or more screws, clamps, clips, ties, combinations thereof, or other suitable fasteners. The door jambs 104 are configured to provide strength to the equipment module 54 and support the weight and movements of the access panel 60 between the opened and closed positions. In one embodiment, the door jambs 104 may be formed from sheet metal that is bent to form an elongate generally U-shaped body 106. The opposed ends of the door jambs 104 may include end caps 108 for connecting the door jambs 104 to the side rails 76, 80 of the top and bottom walls 66, 68 respectively. In one embodiment, the end caps 108 and U-shaped body 106 may be integrally formed such that the door jambs 104 have a substantially monolithic construction. In this regard, and by way of example, the door jambs 104 may be formed from a single sheet metal blank that is bent or folded to form the U-shaped body 106 and the end caps 108 as integral elements. It should be understood, however, that the door jambs 104 may be made from other materials and from other processes. For example, the door jambs 104 may be made from a plastic material through a molding process.

In one embodiment, the access panel 60 includes an elongate generally planar main panel 110 sized similar to the rear wall 64 of the main frame 56 of the equipment module 54 and a flange 112 extending about at least a position of the periphery of the main panel 110. The access panel 60 may be attached to one of the door jambs 104 via a plurality of hinges 114 (e.g., three hinges 114 illustrated in FIG. 3) that allows the access panel 60 to rotate between the closed and opened positions. Although not shown, the access panel 60 may further include a handle, knob, pull, or other item that allows a technician to move the access panel from at least the closed position to the opened position. Moreover, the equipment module 54 may include a lock or latch (not shown) for maintaining the access panel 60 in the closed position.

To complete the assembly of the equipment unit 50 from one or more equipment modules 54, side walls 116 may be connected to the main frame 56 on opposed sides of the equipment unit 50. In one embodiment, each of the side walls 116 may include an elongate generally planar main panel 118 and a flange 120 extending about at least a portion of the periphery of the main panel 112. The height H_{sw} of the side walls 116 generally corresponds to the height Hₘ of the equipment module 54, and the width W_{sw} of the side walls 116 generally corresponds to the depth Dₘ of the equipment module 54.

In one embodiment, each of the side walls 116 may have a slip fit with the main frame 56 of the equipment module 54. For example, a rear side edge of each of the side walls 116 may include one or more tabs 122 extending therefrom. Additionally, the rear wall 64, and more particularly the side rails 72 of the rear wall 64, may include one or more slots 124 configured to receive a corresponding tab 122 of the side walls 116. Thus, to attach a side wall 116 to the main frame 56, the side wall 116 may be positioned such that the one or more tabs 122 generally align with the one or more slots 124 in the side rails 72 of the rear wall 64. The side wall 116 may then be moved (e.g., slid) so that the one or more tabs 122 enter and engage with the one or more slots 124. This provides a strong connection between the side walls 116 and the main frame 56 along the rear of the equipment unit 50.

Furthermore, in one embodiment, each of the side walls 116 may releasably engage with the main frame 56 along a front of the equipment unit 50. In this regard, in one embodiment, the upper and lower flanges 120 of the side walls 116 may include one or more spring pins 126 or other clips for further securing the side walls 116 to the main frame 56 of the equipment unit 50. Each of the spring pins 126 may be moveable between a compressed position and an extended position. With the rear one or more tabs 122 engaged with the one or more slots 124 and the front side of the side wall 116 just outboard of the main frame 56, the spring pins 126 may be compressed and the side wall 116 moved towards the main frame 56 so that the lower edge of the side wall 116 overlies the side rail 80 of the bottom wall 68 and the upper edge of the side wall 116 underlies the side rail 76 of the top wall 66. The side rail 80 of the bottom wall 68 and the side rail 76 of the top wall 66 include openings 128 adjacent the front of the equipment unit 50. The openings 128 in the side rails 76, 80 generally align with the spring pins 126 in the upper and lower flanges 120 of the side walls 116. Thus, as the side walls 116 are being moved toward the main frame 56, the spring pins 126 snap back to the extended position when they encounter the openings 128 to thereby releasably secure the front of the side walls 116 to the main frame 56 of the equipment unit 50.

In use, when the equipment unit 50 is fully assembled and the access panel 60 is in the closed position, the support wall 82 of the carrier 58 is in the retracted position and the network components 52 are safely contained within the equipment unit 50 in an organized manner (see FIG. 3). When it is necessary or desired to access the network components 52 in the equipment unit 50, a technician may move the access panel 60 from the closed position to the opened position. Then the technician may move the support wall 82 of the carrier 58 from the retracted position to the extended position to expose the network components 52 held by the at least one support wall 82 (see FIG. 5). In this regard, both sides of the at least one support wall 82 are exposed when the at least one support wall 82 is in the extended position. At this point, the technician may access one or more of the network components 52 to complete an installation or make a modification to an existing installation. When the technician has completed the installation or the modification, the technician may then move the at least one support wall 82 of the at least one carrier 58 from the extended position back to the retracted position so as to be contained within the equipment unit 50. The access panel 60 may then be moved from the opened position to the closed position.

Assembly of the equipment unit 50 is now described in an exemplary embodiment of the disclosure. As noted above, the main frame 56 may be provided as a substantially monolithic structure. If not, then the main frame 56 may be formed by assembling the rear wall 64, the top wall 66, and the bottom wall 68 together to form the U-shaped body of the main frame 56. Each of the rear wall 64, top wall 66, and bottom wall 68 may have a substantially monolithic construction as well. If not, then each of these walls 64, 66, 68 may be formed by connecting their main panels 70, 74, 78 with their respective side rails 72, 76, 80 to form the walls 64, 66, 68.

Next, the access panel 60 may be assembled to the main frame 56. In this regard, the door jambs 104 may be attached to the main frame 56 so as to extend between the top wall 66 and the bottom wall 68 along the front of the equipment unit 50. The access panel 60 may then be connected to one of the door jambs 104 by one or more hinges 114 such that the access panel 60 is rotatable between the closed position and the opened position.

Next, the at least one carrier 58 may be attached to the main frame 56. More particularly, the upper and lower sliders 86, 88 may be attached to the main frame 56, such as along the top wall 66 and the rear wall 64, respectively. In one embodiment, the at least one support wall 82 and the sliders 86, 88 may form an assembly that is attached to the main frame 56 as a unit. In an alternative embodiment, the sliders 86, 88 may first be attached to the main frame 56 and then the at least one support wall 82 may be attached to the sliders 86, 88. In a further alternative embodiment, the at least one carrier 58 may be attached to the main frame 56 prior to the access panel 60 being attached to the main frame 56. In one embodiment, once the at least one carrier 58 is attached to the main frame 56, the network components 52 may be secured to the at least one support wall 82, such as on both surfaces 84 thereof. In an alternative embodiment, the network components 52 may be secured to the at least one support wall 82 prior to the at least one support wall 82 being attached to the main frame 56.

In a subsequent step according to the method, the pair of side walls 116 may be attached to the main frame 56. In this regard, the side walls 116 may be positioned such that the one or more tabs 122 of the side walls 116 align with the one or more slots 124 in the side rails 72 of the rear wall 64. The side walls 116 may then be slid rearwardly so that the one or more tabs 122 enter and engage with corresponding one or more slots 124 in the main frame 56. The spring pins 126 in the side walls 116 may then be compressed and the front of the side walls 116 may be moved toward the main frame 56 until the spring pins 126 snap back to the extended position within the openings 128 in the side rails 76, 80 of the top wall 66 and the bottom wall 68, respectively.

In one aspect of the disclosure, the equipment unit 50 may have a modular design including one or more equipment modules 54 connected to each other in a side-by-side arrangement. As noted above, the equipment unit 50 may include only one equipment module 54 as shown in FIG. 3, for example. However, as shown in FIGS. 6 and 7, the equipment unit 50 may be formed from a plurality of equipment modules 54 with adjacent equipment modules 54 being connected to each other along their respective confronting sides. For example, adjacent equipment modules 54 may be connected by one or more screws, bolts, clips, ties, brackets, or other suitable fasteners. FIGS. 6 and 7 illustrate an equipment unit 50 formed from four equipment modules 54 but the number may be more or less than this value depending on the particular application.

The assembly of the multi-module equipment unit 50 is similar to that described above. The primary difference is that each of the main frames 56 of the equipment modules 54 is connected to the main frame 56 of at least one adjacent equipment module 54. In one embodiment, connection of adjacent main frames 56 may occur prior to the connection of the respective carriers 58 and/or the respective access panels 60 to the equipment modules 54. In another embodiment, connection of the adjacent main frames 56 may occur after the connection of the respective carriers 58 and/or the respective access panels 60 to the equipment modules 54. In yet another embodiment, some partial assembly of the main frames 56 to adjacent main frames 56 may occur during partial assembly of the respective carriers 58 and/or the respective access panels 60. After the desired number of main frames 56 of the equipment modules 54 have been assembled, the side walls 116 may be attached to the end most equipment modules 54, such as in the manner described above. In one embodiment, the equipment unit 50 only includes two side walls 116, i.e., there are no side walls 116 between adjacent equipment modules 54.

While the above was described in a certain order in various embodiments, it should be recognized that the order of assembly may include a different order of the assembly steps. Those having ordinary skill in the art may recognize a different order to the assembly steps than that disclosed herein but arrive at a fully assembled equipment unit 50. Such alternative ordering of the method steps is considered within the scope of the present disclosure.

One benefit of the modular construction of the equipment unit 50 is that the equipment unit 50 may be expanded in an easy and straight forward manner. For example, when the capacity of an equipment unit 50 is to be increased, an additional equipment module 54 may be assembled to one of the ends of the existing equipment unit 50. In this regard, for example, at the selected end of the equipment unit 50 that is to be expanded, the side wall 116 at that end may be removed from the end most main frame 56, such as by compressing the spring pins 126 and disengaging the one or more tabs 122 from their respective one or more slots 124. The main frame 56 of the additional equipment module 54 may then be assembled, if necessary, and connected to the end most main frame 56. The previously removed end wall 116 may then be reconnected to the added main frame 56 on an outer side thereof to complete the assembly of the now expanded equipment unit 50.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The disclosure in its broader aspects is therefore not limited to the specific details, representative apparatus and methods and illustrative examples shown and described. Instead, it should be evident that departures may be made from such details without departing from the scope of the disclosure.

What is claimed is:

1. An equipment unit for a fiber optic network configured to hold a plurality of network components, comprising:
at least one equipment module, each of the at least one equipment modules comprising:
a main frame defining an interior and exterior; and
at least one carrier attached to the main frame and including at least one support wall moveable between a retracted position and an extended position and configured to receive the plurality of network components,
wherein the at least one carrier is attached to the main frame such that the at least one support wall has a substantially vertical orientation,
wherein in the retracted position, the at least one support wall is positioned in the interior of the main frame, and
wherein in the extended position, the at least one support wall is positioned in the exterior of the main frame.

2. The equipment unit of claim 1, wherein the main frame comprises:
a rear wall;
a top wall extending from an upper edge of the rear wall; and
a bottom wall extending from a lower edge of the rear wall.

3. The equipment unit of claim 2, wherein each of the rear wall, top wall, and bottom wall comprises:
a main panel; and
a pair of side rails adjacent opposed side edges of the main panel.

4. The equipment unit of claim 1, wherein the at least one carrier further comprises:
a first slider attached to the main frame and the at least one support wall; and
a second slider attached to the main frame and the at least one support wall,
wherein the at least one support wall is slidable along the first slider and the second slider between the retracted position and the extended position.

5. The equipment unit of claim 4, wherein each of the first slider and the second slider comprises:
a mounting bracket attached to the main frame; and
one or more arms slidably attached to the mounting bracket.

6. The equipment unit of claim 4, wherein the main frame comprises:
a rear wall;
a top wall extending from an upper edge of the rear wall;
a bottom wall extending from a lower edge of the rear wall; and
wherein the first slider is attached to the top wall of the main frame and the second slider is attached to the rear wall of the main frame.

7. The equipment unit of claim 1, wherein the at least one equipment module further comprises an access panel attached to the main frame and moveable between a closed position and an opened position, wherein the at least one equipment module further comprises a pair of door jambs attached to the main frame, and wherein the access panel is attached to at least one of the pair of door jambs.

8. The equipment unit of claim 1, further comprising a pair of side walls, wherein each of the pair of side walls is releasably attached to the main frame of one of the at least one equipment modules of the equipment unit.

9. The equipment unit of claim 8, wherein each of the pair of side walls includes one or more tabs and the one of the main frames includes a corresponding one or more slots, and wherein the one or more tabs are configured to engage with the corresponding one or more slots when the pair of side walls are attached to the main frame of the one of the at least one equipment modules of the equipment unit.

10. The equipment unit of claim 8, wherein each of the pair of side walls includes at least one snap fit connector configured to releasably engage with the main frame of the one of the at least one equipment modules of the equipment unit.

11. The equipment unit of claim 1, wherein the at least one equipment module includes a plurality of equipment modules arranged in a side-by-side manner, and wherein each of the plurality of equipment modules is connected to at least one other equipment module of the plurality of equipment modules.

12. A method of assembling an equipment unit for a fiber optic network from at least one equipment module, the equipment unit configured to hold a plurality of network components, for each of the at least one equipment modules, the method comprising:
providing a main frame of the at least one equipment module that defines an interior and an exterior; and
attaching at least one carrier to the main frame, the at least one carrier including a least one support wall moveable between a retracted position and an extended position and configured to receive the plurality of network components,
wherein attaching the at least one carrier to the main frame includes attaching the at least one carrier to the main frame so that:
the at least one support wall has a substantially vertical orientation,
in the retracted position, the at least one support wall is positioned in the interior of the main frame, and
in the extended position, the at least one support wall is positioned in the exterior of the main frame.

13. The method of claim 12, wherein attaching the at least one carrier to the main frame includes attaching the at least one carrier to the main frame so that the at least one support wall is slidable between the retracted position and the extended position.

14. The method of claim 13, further comprising attaching an access panel to the main frame so as to be moveable between a closed position and an opened position, the access panel configured to provide selective access to the plurality of network components in the equipment unit, wherein attaching the access panel to the main frame further comprises:
attaching a pair of door jambs to the main frame; and
attaching the access panel to at least one of the pair of door jambs.

15. The method of claim 12, further comprising attaching a pair of side walls to the main frame of the one of the at least one equipment modules of the equipment unit.

16. The method of claim 15, wherein attaching the pair of side walls to the main frame of the one of the at least one equipment modules of the equipment unit includes attaching each of the pair of side walls to the main frame through a slip fit or a snap fit.

17. The method of claim 12, wherein the main frame includes a rear wall, top wall, and bottom wall, and wherein providing the main frame includes attaching each of the top wall and the bottom wall to the rear wall to form the main frame.

18. The method of claim 12, wherein the equipment unit includes a plurality of equipment modules, the method further comprising:
attaching the main frame of each of the plurality of equipment modules to the main frame of at least one adjacent equipment module of the plurality of equipment modules so as to arrange the plurality of equipment modules in a side-by-side manner.

19. The method of claim 18, wherein the equipment unit includes a first end equipment module and a second end equipment module, and wherein attaching the pair of side walls comprises:
attaching one of the pair of side walls to the main frame of the first end equipment module; and
attaching the other of the pair of side walls to the main frame of the second end equipment module.

20. A method of expanding the capacity of an equipment unit for a fiber optic network formed from at least one equipment module, the equipment unit configured to hold a plurality of network components, the method comprising:
removing a side wall from the equipment unit at a selected end of the equipment unit;
providing a main frame of an additional equipment module that defines an interior and an exterior;
attaching at least one carrier to the main frame of the additional equipment module, the at least one carrier including a least one support wall moveable between a retracted position and an extended position and configured to receive the plurality of network components;
attaching an access panel to the main frame of the additional equipment module; and
reattaching the removed side wall to the main frame of the additional equipment module,
wherein attaching the at least one carrier to the main frame of the additional equipment module includes attaching the at least one carrier to the main frame so that:
the at least one support wall has a substantially vertical orientation,
in the retracted position, the at least one support wall is positioned in the interior of the main frame of the additional equipment module, and
in the extended position, the at least one support wall is positioned in the exterior of the main frame of the additional equipment module.
